(19) United States
(12) Patent Application Publication
(10) Pub. No.: US 2025/0239645 A1
(43) Pub. Date: Jul. 24, 2025

(54) OXIDE-BASED THREE-LAYER STRUCTURE COMPOSITE ELECTROLYTE AND ALL-SOLID-STATE BATTERY USING THE SAME

(71) Applicant: KOREA INSTITUTE OF ENERGY RESEARCH, Daejeon (KR)

(72) Inventors: Dae Il KIM, Daejeon (KR); Bo Yun JANG, Daejeon (KR); Joon Soo KIM, Sejong-si (KR); Ji Haeng YU, Daejeon (KR)

(73) Assignee: KOREA INSTITUTE OF ENERGY RESEARCH, Daejeon (KR)

(21) Appl. No.: 18/820,574

(22) Filed: Aug. 30, 2024

(30) Foreign Application Priority Data
Jan. 19, 2024 (KR) 10-2024-0008582

(51) Int. Cl. H01M 10/056; H01M 4/04; H01M 4/62

(52) U.S. Cl. CPC H01M 10/056; H01M 4/0407; H01M 4/623; H01M 4/624

(57) ABSTRACT

An embodiment of the present invention provides a three-layer structure composite electrolyte including an oxide-based solid electrolyte center layer (CSE, composite solid electrolyte); and an ionic polymer interlayer (IPI) disposed on both sides of the solid electrolyte center layer.

### BACKGROUND OF THE INVENTION

### Field of the Invention

The present invention relates to an oxide-based three-layer structure composite electrolyte, more particularly to a composite solid electrolyte with a three-layer structure in which GD-CSE (garnet dominant-composite solid electrolyte) is the center layer and IPI (ionic polymer interlayer) is the upper and lower layers, and an all-solid-state battery using the same.

### Description of the Related Art

Lithium-ion batteries (LIB) play an important role in a variety of areas ranging from portable electronic devices to grid-scale energy storage systems. However, LIBs have various safety issues, such as fire, explosion, and leakage of flammable organic liquid electrolytes, and have a limited energy density of 250 Wh/kg. Therefore, advanced next-generation LIBs, such as SSBs, Li-metal batteries, Li-sulfur batteries, and Li-air batteries, have received great attention to solve such safety issues and overcome the limited energy density. In particular, SSBs using oxide, sulfide or polymer electrolytes have received widespread attention because of their high safety and utility for high energy density-Li-metal batteries.

Oxide-based solid electrolytes have an ionic conductivity range of 10⁻⁵ to 10⁻³ S/cm, high chemical and electrochemical stability, and mechanical strength, but lack flexibility for large-area production and require high processing costs. In particular, garnet-based electrolytes such as LLZO (Li₇La₃Zr₂O₁₂) have great feasibility for high safety-solid-state battery applications because of their non-flammability, high ionic conductivity, wide electrochemical window, and excellent chemical stability against Li. However, ceramic solid electrolytes come into poor interfacial contact with electrodes, are generally thick and brittle, and therefore do not meet the requirements for thin film formation, making it difficult to put the ceramic solid electrolytes into practical use. Meanwhile, polymer electrolytes exhibit excellent mechanical flexibility and excellent adhesive properties to electrodes, and are easily formed into thin films, but have a great limitation to be put into practical use because of their low ionic conductivity at room temperature, insufficient electrochemical stability, and poor flame retardancy.

Hence, ceramic-polymer composite solid electrolytes containing ceramic components at high contents (>50 wt. %) have been considered promising candidates for high-safety SSBs because of their excellent electrochemical performance and thermal stability. Composite solid electrolytes containing ceramic powder or fibers as a filler in a polymer matrix have achieved a higher ionic conductivity, a wider electrochemical window, and a higher Li-ion transfer number compared to pure polymer electrolytes. Nevertheless, the content of ceramic filler in the polymer matrix is limited because of filler aggregation which lowers the ionic conductivity of the composite electrolyte.

A number of SSB researchers have conducted studies on oxide solid electrolytes. In particular, various studies have been conducted to apply high content-oxide solid electrolytes. First, in a prior art, a 3D Li_{6.75}La₃Zr_{1.75}Ta_{0.25}O₁₂ (LLZTO) self-contained framework interconnected with a polytetrafluoroethylene (PTFE) binder is manufactured through a simple grinding method without a solvent. This non-flammable and highly processable composite electrolyte film has a wide electrochemical window of up to 4.8 V versus Li/Lit, and a high Li-ion transfer number of 0.53 because of a high content of garnet ceramic (80.4 wt. %) and high heat resistance of the PTFE binder. The soft electrolyte/electrode interface jointly contributes to the high ambient temperature ionic conductivity of 1.2×10⁻⁴ S cm⁻¹ and the excellent long-term stability of the symmetric Li cell. In addition, LiFePO₄ (LFP)|Li and LiNi_{0.5}Co_{0.2}Mn_{0.3}O₂ (NCM)|Li cells as manufactured exhibit high specific discharge capacities of 153 and 158 mAh g⁻¹, respectively, and desirable cyclic stability at room temperature.

In another prior art, a composite electrolyte containing LLZO at 80 wt. % and a polymer at 20 wt. % has a Li-ion conductivity of 1.31×10⁻⁴ S/cm and a transfer number (trit) of 0.84 at 60° C. The prepared composite electrolyte also exhibits electrochemical stability of up to 5.4 V versus Li/Li⁺. LFP|composite electrolyte|Li-metal solid-state cell provides a discharge capacity of 140 mAh/g and adequate cycling stability at 55° C. and 0.02 C after 40 cycles.

The composite solid electrolyte of the present invention is characterized by a composite solid electrolyte (CSE) with a three-layer structure in which a garnet dominant-composite solid electrolyte (GD-CSE) is the center layer and an ionic polymer interlayer (IPI) is the upper and lower layers. GD-CSE contains LGLZO (80 wt. %), poly (vinylidene fluoride-co-hexafluoropropylene) (PVDF-HFP, 5 wt. %), and a plastic crystal electrolyte (PCE, LiTFSI dolven succinonitrile, 15 wt. %) as an ionic-conductive additive. IPI contains PVDF-HFP as a framework and a plastic crystal electrolyte an ionic-conductive component. The mechanical strength of the three-layer structure composite electrolyte of the present invention can be enhanced by configuring a three-layer structure, and the lithium ion conductivity of the three-layer structure-CSE can be improved by introducing an IPI layer.

### SUMMARY OF THE INVENTION

A technical object to be achieved by the present invention is to solve the problem that conventional oxide-based solid electrolytes lack flexibility and require high processing costs for large-area production although the electrolytes have an ionic conductivity range of 10⁻⁵ to 10⁻³ S/cm and exhibit high chemical and electrochemical stability and mechanical strength.

Another technical object is to solve the problem that particularly garnet-based electrolytes such as LLZO (Li₇La₃Zr₂O₁₂) have great feasibility for high-safety solid-state battery applications because of their non-flammability, high ionic conductivity, broad electrochemical stability, and excellent chemical stability against lithium, but ceramic solid electrolytes come into poor interfacial contact with electrodes and are generally thick and brittle, and therefore do not meet the requirements for thin and flexible film formation, making it difficult to put the ceramic solid electrolytes into practical use.

The technical objects to be achieved by the present invention are not limited to the technical objects mentioned above, and other technical objects not mentioned will be clearly understood by those skilled in the art to which the present invention pertains from the description below.

As a technical means for achieving the above-described technical objects, an aspect of the present invention provides
a three-layer structure composite electrolyte including an oxide-based solid electrolyte center layer (CSE: composite solid electrolyte); and an ionic polymer interlayer (IPI) disposed on both sides of the solid electrolyte center layer.

The oxide-based solid electrolyte center layer (composite solid electrolyte) may contain an oxide-based solid electrolyte at 75 to 90 wt %; a binder at 5 to 20 wt %; and an ionic-conductive additive at 5 to 20 wt %.

The oxide-based solid electrolyte may be in a powder form and have a garnet structure.

The oxide-based solid electrolyte may have an average powder diameter (D50 in volumetric intensity) of 0.5 to 20 μm.

The oxide-based solid electrolyte may be a garnet-type oxide-based solid electrolyte represented by the following Chemical Formula 1:

Li₇₋ₓMₓLa₃Zr₂₋ₓO₁₂ [Chem. 1]
(in Chemical Formula 1, M is at least one selected from the group consisting of Ga, Ta, Y, Sc, and Nb, and x is less than 0.7).

The binder of the solid electrolyte may be one selected from a poly (vinylidene fluoride-co-hexafluoropropylene) (PVDF-HFP) composite porous polymer, PVDF, or a copolymer thereof.

The solid electrolyte may contain a plastic crystal electrolyte (PCE) as an ion conductive additive.

The plastic crystal electrolyte (PCE) may contain lithium bis(trifluoromethanesulfonyl)imide (LiTFSI) and succinonitrile (SN) or a dinitrile.

The plastic crystal electrolyte (PCE) may be prepared by mixing lithium bis(trifluoromethanesulfonyl)imide (LiTFSI) and succinonitrile (SN) or a dinitrile at a ratio of 1 to 8 to 20 mol. %.

The binder of the ionic polymer interlayer may be one selected from a poly (vinylidene fluoride-co-hexafluoropropylene) (PVDF-HFP) composite porous polymer, PVDF, or a copolymer thereof.

The ionic polymer interlayer may contain a plastic crystal electrolyte (PCE) as an ion conductive additive.

The plastic crystal electrolyte (PCE) may contain lithium bis(trifluoromethanesulfonyl)imide (LiTFSI) and succinonitrile (SN) or a dinitrile.

The plastic crystal electrolyte (PCE) may be prepared by mixing lithium bis(trifluoromethanesulfonyl)imide (LiTFSI) and succinonitrile (SN) or a dinitrile at a ratio of 1 to 8 to 20 mol. %.

The thickness of the three-layer structure composite electrolyte may be 30 to 200 μm.

The ionic conductivity of the three-layer structure composite electrolyte may be 0.5 to 1.2 mS/cm.

In order to achieve the technical objects, another aspect of the present invention provides an all-solid-state battery manufactured using the three-layer structure composite electrolyte according to item 1.

### BRIEF DESCRIPTION OF THE DRAWINGS

FIG. 1 illustrates the manufacturing mechanism and morphological characteristics of a three-layer composite solid electrolyte: A) schematic diagram of the design and structure of the three-layer structure-CSE including GD-CSE and IPI, B) SEM image (top) and XRD analysis (bottom) of LGLZO powder, C) top view image (top) and bent state image of the three-layer structure-CSE (bottom) having a size of 5×5 cm, and D) a cross-sectional SEM image of the three-layer structure-CSE and corresponding EDS elemental mapping of La, Ga and F;

FIG. 2 illustrates the electrochemical properties of a three-layer structure-CSE: A) an Arrhenius plot of ionic conductivity for the three-layer structure-CSE having two different PCE concentrations, B) linear sweep voltage (LSV) for the three-layer structure-CSE at 25° C. (LiTFSI:SN=1:8 mol. %), D) a polarization curve and initial and steady-state impedance diagrams of the three-layer structure-CSE having a LiTFSI concentration of LiTFSI:SN=1:19 mol. %, and E) a galvanostatic cycling curve of a symmetric Li cell including the three-layer structure-CSE at 0.1 mA cm⁻² (inset images above and below show enlarged galvanostatic cycling curves);

FIG. 3 illustrates various analyses of IPI, GD-CSE, three-layer-CSE, PCE, and LGLZO: A) XRD, B) FT-IR, C) Raman spectroscopy, and D) TGA;

FIG. 4 illustrates the electrochemical properties of a solid-state battery including a three-layer structure-CSE: A) the charge and discharge voltage profile of an LFP|three-layer structure-CSE (having two different PCE concentrations)|Li-metal cell at 0.1 C and 25° C., B) the C-rate characteristics and scan rate at 0.1 C to 5.0 C of an LFP|three-layer structure-CSE (1:19)|Li-metal cell at 25° C., C) corresponding cycling stability of an LFP|three-layer structure-CSE (1:19)|Li-metal cell at 0.5 C and 25° C., and E) corresponding cycling stability of an NCM622|three-layer structure-CSE (1:19)|Li-metal cell at 0.1 C and 25° C.;

FIG. 5 illustrates the electrochemical and deformable properties of a solid-state pouch cell including a three-layer structure-CSE: A) a photographic image of a 3450-sized solid-state pouch cell, B) an LFP|three-layer structure-CSE (1:19)|Li-metal cell, C) corresponding cycling stability at 0.1 C and 25° C., and D) bending and cutting tests of a solid-state pouch cell;

FIG. 6 illustrates images of plastic crystal electrolytes having different concentrations at different temperatures of 25° C. and 60° C., respectively: A) and B) LITFSI:succinonitrile=1:8 mol % and 1:19 mol % at 25° C., and C) and D) LITFSI:succinonitrile=1:8 mol % and 1:19 mol % at 60° C.;

FIG. 7 illustrates a graph of the particle size distribution of LGLZO particles;

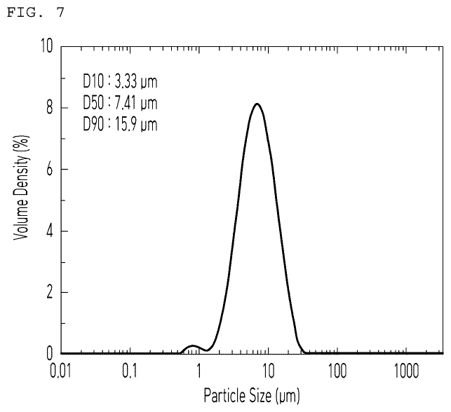

FIG. 8 illustrates an Arrhenius plot of ionic conductivity for an ionic polymer interface with a plastic crystal: A) LGLZO pellets and B) LiTFSI:SN=1:19 mol. %;

FIG. 9 illustrates the rate performance of a Li|Li symmetric cell at various current densities of 0.1 mA/cm² to 1.0 mA/cm²: A) IPI (1:8 mol %), B) IPI (1:19 mol %), C) three-layer structure-CSE (1:8 mol %), and D) three-layer structure-CSE (1:19 mol %);

FIG. 10 illustrates FT-IR analysis result data of various solid electrolytes;

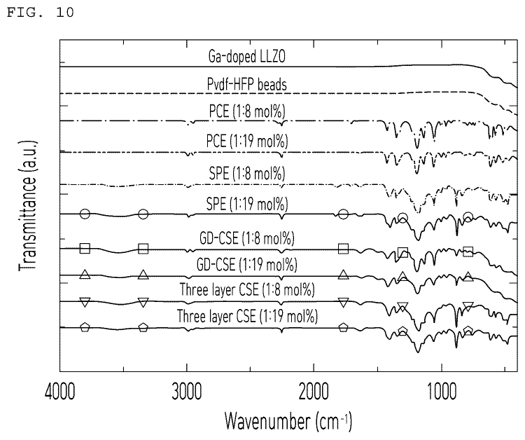

FIG. 11 illustrates TGA analysis data of IPI, GD-CSE, and three-layer structure-CSE having a PCE concentration of 1:8 mol. %;

FIG. 12 illustrates data on A) an LFP|3-layer structure-CSE (1:19)|lithium metal cell before and after constant current cycling at 0.5 C and 25° C. by EIS and B) an NCM622|3-layer structure-CSE (1:19)|lithium metal cell before and after constant current cycling at 0.1 C and 25° C. by EIS; and

FIG. 13 illustrates the equivalent circuit of an LFP|3-layer structure-CSE (1:19)|lithium metal cell before and after constant current cycling and the equivalent circuit of an NCM622|3-layer structure-CSE (1:19)|lithium metal cell before and after constant current cycling, where Rₛ denotes the electronic resistance of the cell and equipment artifacts, R_{SEI} and C₁ denote the resistance and capacitance at the electrode-electrolyte interface, R_{CT} and C₂ denote the charge transfer resistance and the associated double layer capacitance, and W denotes the Warburg diffusion before and after cycling, respectively.

### DETAILED DESCRIPTION OF THE PREFERRED EMBODIMENTS

Hereinafter, the present invention will be described in more detail. However, the present invention can be implemented in various different forms and is not limited to the embodiments described herein, and the present invention is only defined by the claims to be described later.

Hereinafter, the present invention will be described with reference to the attached drawings. However, the present invention can be implemented in various different forms and, therefore, is not limited to the embodiments described herein. In the drawings, in order to clearly explain the present invention, parts unrelated to the description are omitted, and similar parts are given similar reference numerals throughout the specification.

Throughout the specification, when a part is said to be “connected (linked, in contact, combined)” with another part, this includes not only cases where they are “directly connected,” but also cases where they are “indirectly connected” with another member in between. In addition, when a part is said to “include” a certain component, this means that it does not exclude other components, but may further include other components, unless specifically stated to the contrary.

The terms used in the present specification are only used to describe specific embodiments and are not intended to limit the present invention. Singular expressions include plural expressions unless the context clearly dictates otherwise. In the present specification, terms such as “include” or “have” should be understood to indicate the presence of features, numbers, steps, operations, components, parts, or combinations thereof described in the specification, but not preclude the presence or addition of one or more other features, numbers, steps, operations, components, parts, or combinations thereof.

A first aspect of the present disclosure provides a three-layer structure composite electrolyte including an oxide-based solid electrolyte center layer (CSE, composite solid electrolyte); and an ionic polymer interlayer (IPI) disposed on both sides of the solid electrolyte center layer.

Hereinafter, the three-layer structure composite electrolyte according to the first aspect of the present disclosure will be described in detail.

In an exemplary embodiment of the present disclosure, the oxide-based solid electrolyte center layer (composite solid electrolyte) may contain an oxide-based solid electrolyte at 75 to 90 wt %; a binder at 5 to 20 wt %; and an ionic-conductive additive at 5 to 20 wt %.

The oxide-based solid electrolyte may have an average powder diameter (D50 in volumetric intensity) of 0.5 to 20 μm, preferably 1 to 15 μm, more preferably 5 to 10 μm.

In an exemplary embodiment of the present disclosure, the oxide-based solid electrolyte may be in the powder form and have a garnet structure, and the oxide-based solid electrolyte may be a garnet-type oxide-based solid electrolyte represented by either of the following Chemical Formula 1 or 2.

Li₇₋ₓMₓLa₃Zr₂₋ₓO₁₂ [Chem. 1]

(In Chemical Formula 1, M is at least one selected from the group consisting of Ga, Ta, Y, Sc, and Nb, and x is less than 0.7.)

LiₓGa_{w}La_{y}Zr₂O₁₂ (5≤x≤9, 2≤y≤4, 1≤z≤3, 0<w≤1) [Chem. 2]

In an exemplary embodiment of the present disclosure, LLZO doped with gallium or the like, as in either of Chemical Formula 1 or 2, may have one or more structures selected from a cubic structure or a tetragonal structure. Preferably, the gallium-doped LLZO may have a single-phase cubic structure, and the cubic structure is known to have a high ionic conductivity and excellent potential safety. Preferably, the oxide-based solid electrolyte may be Li_{6.25}Ga_{0.25}La₃Zr₂O₁₂.

In an exemplary embodiment of the present disclosure, the binder of the solid electrolyte may contain any one selected from polyvinylidene fluoride, polyethylene oxide, polypropylene oxide, polystyrene, polyetherimide, polyethersulfone, polysiloxane, polysulfone, polyphenylene oxide, polyhexafluoropropylene, polyacrylonitrile, or polymethyl methacrylate, or a mixture of two or more thereof, or a copolymer of two or more thereof, and preferably the binder may be one selected from a poly (vinylidene fluoride-co-hexafluoropropylene) (PVDF-HFP) composite porous polymer, PVDF, and a copolymer thereof.

In an exemplary embodiment of the present disclosure, the solid electrolyte may contain a plastic crystal electrolyte (PCE) as an ion conductive additive. In this case, the plastic crystal refers to a substance in an intermediate state between solid and liquid, and such a substance has a crystal structure, but has a property in which the molecules show certain fluidity in the crystal lattice. This is a unique state that has both the crystalline structure of a solid and the fluidity of a liquid, and these substances have a variety of applications in technology and materials science fields, for example, plastic crystals may be used in display technology, sensors, memory devices, and the like.

In an exemplary embodiment of the present disclosure, the plastic crystal electrolyte (PCE) may contain lithium bis(trifluoromethanesulfonyl)imide (LiTFSI) and succinonitrile (SN) or a dinitrile, and may be prepared by mixing lithium bis(trifluoromethanesulfonyl) imide (LiTFSI) and succinonitrile (SN) or a dinitrile at a ratio of 1 to 8 to 20 mol. %.

In an exemplary embodiment of the present disclosure, the binder of the ionic polymer interlayer may contain any one selected from polyvinylidene fluoride, polyethylene oxide, polypropylene oxide, polystyrene, polyetherimide, polyethersulfone, polysiloxane, polysulfone, polyphenylene oxide, polyhexafluoropropylene, polyacrylonitrile, or polymethyl methacrylate, or a mixture of two or more thereof, or a copolymer of two or more thereof, and preferably the binder may be one selected from a poly (vinylidene fluoride-co-hexafluoropropylene) (PVDF-HFP) composite porous polymer, PVDF, and a copolymer thereof.

In an exemplary embodiment of the present disclosure, the solid electrolyte may contain a plastic crystal electrolyte (PCE) as an ion conductive additive, and the plastic crystal electrolyte (PCE) may contain lithium bis(trifluoromethanesulfonyl)imide (LiTFSI) and succinonitrile (SN) or a dinitrile, and may be prepared by mixing lithium bis(trifluoromethanesulfonyl) imide (LiTFSI) and succinonitrile (SN) or a dinitrile at a ratio of 1 to 8 to 20 mol. %.

In an exemplary embodiment of the present disclosure, the thickness of the three-layer structure composite electrolyte may be 30 to 200 μm, and the ionic conductivity of the three-layer structure composite electrolyte may be 0.5 to 1.2 mS/cm.

In an exemplary embodiment of the present disclosure, the three-layer CSE has been designed from three perspectives. In terms of materials, we have tried to contain LGLZO as much as possible since LGLZO is not only a single ion conductor but also an effective material for Li-dendrite growth. In order to fully utilize the performance of LGLZO in the polymer-in-ceramic model, the LGLZO content is required to be at least 80 wt. % or more. However, a large amount of LGLZO leads to a relatively small amount of PVDF-HFP binder, and this weakens the layer to the degree at which it is not easy to handle the layer. Therefore, by applying two IPI layers on both sides of the CSE layer, the mechanical strength was sufficiently enhanced to be applied to various cell fabrication. Finally, when the middle layer is in direct contact with the anode and cathode, the LGLZO powder protruding from the surface irregularly increases the interfacial resistance with the electrode. Therefore, by disposing IPI between the electrode and the electrolyte, a smooth and regular interface is formed and a decrease in interfacial resistance can be expected.

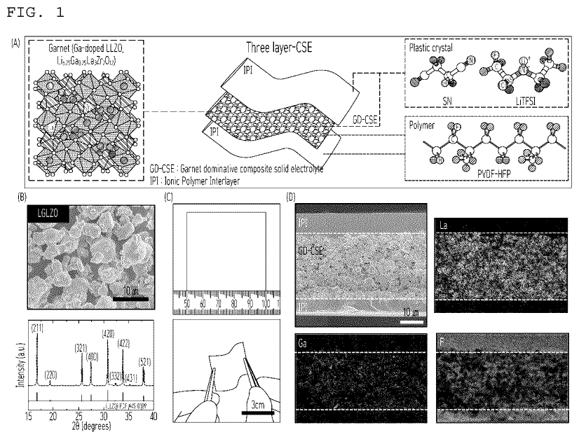

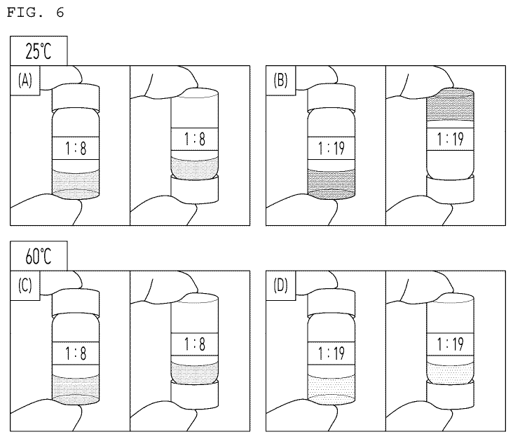

In an exemplary embodiment of the present disclosure, in order to achieve a high ionic conductivity of the electrolyte, plastic crystal electrolytes (PCE) were prepared by mixing lithium bis(trifluoromethanesulfonyl)imide (LiTFSI) and succinonitrile (SN) having two different concentrations at a molar ratio of 1:8 and 1:19, respectively. As a frequently used plastic crystal substance, SN exhibits high polarity to have a high solubility of Li-salts in the temperature range of approximately −35° C. to 62° C. When heated to a melting point of about 60° C., the two PCEs change to a liquid state exhibiting favorable fluidity, and the pores of the center layer can be filled with LGLZO at a high content. (FIGS. 6A and 6B) After cooling, LiTFSI:SN=1:19 mol. % was restored to the solid state as illustrated in FIG. 1D, and the compressibility and flexibility of the composite solid electrolyte was maintained. On the other hand, PCE having another concentration of LiTFSI:SN=1:8 mol. %, still remained in the liquid state. (FIG. 6C)

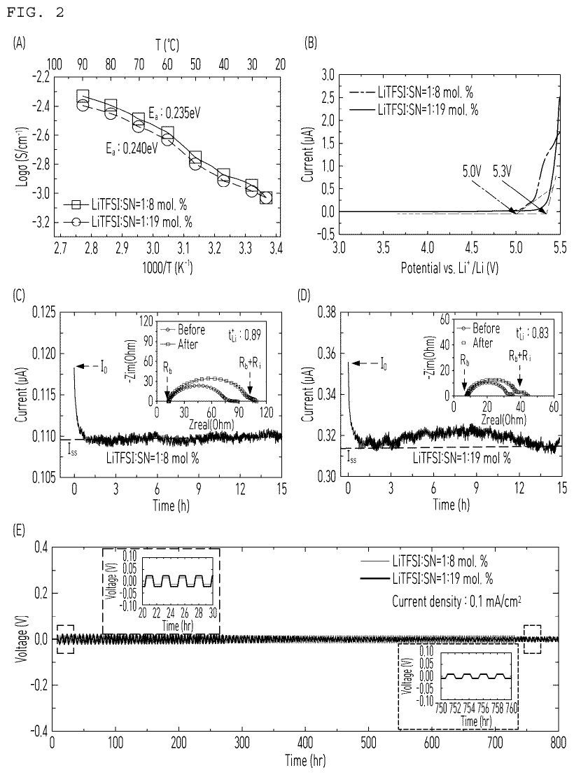

In an exemplary embodiment of the present disclosure, the IPI layer contains PVDF-HFP as the backbone and a plastic crystal electrolyte (PCE) which is a Li-ion conductive substance. In the case of these three layered-CSEs, LGLZO has been synthesized by mixing, sintering, and pulverization processes. It can be seen from the SEM image in FIG. 1B (top) and the particle size distribution (PSD) graph in FIG. 2 that the synthesized LGLZO has a spherical shape and particle size of 7.41 μm (D50). All signals of the obtained LGLZO matches well with the signals of the (211), (220), (321), (400), (420), (332), (422), (431), and (521) planes of cubic phase LGLZO (PDF #45-0109). In the XRD pattern of a specimen, other noticeable signals were not found in the 2θ range of 20° to 30°, such as those of La_{q}Zr₂O₇ or substances containing Ga³⁺. These results indicate that Ga³⁺ has been successfully incorporated into the main crystal structure of the synthesized LLZO. As a result, it can be seen that LGLZO synthesized in the present invention has a perfect cubic phase and does not have a secondary phase.

In an exemplary embodiment of the present disclosure, as illustrated in FIG. 1C, CSE is prepared in a large size of 5×5 cm² and exhibits favorable flexibility. The cross-sectional SEM and energy dispersive spectrum (EDS) mapping images of the three-layer structure-CSE are presented in FIG. 1D, and this shows the thin (about 30 μm) thickness of the GD-CSE electrolyte and a thin (about 10 μm) thickness of the IPI layer on each side. In particular, LGLZO is well distributed in the center layer that is also a dense layer. The pores detected in the middle layer may be due to evaporation of a part of CSE during the exhaust process before SEM measurement. The IPI layer is also a dense layer without any micropore, and it can be seen that the EDS mapping reveals the uniform distribution of PVDF-HFP in the LGLZO framework (middle layer), and the fluorine mapping (top and bottom layers) shows dense IPI layers.

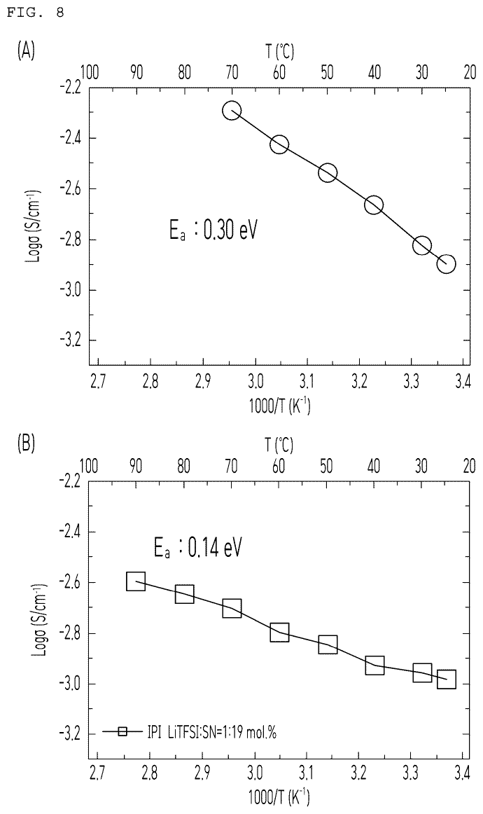

In an exemplary embodiment of the present disclosure, the Arrhenius plot of the ionic conductivity of three-layer structure-CSEs based on different PCE concentrations is illustrated in FIG. 2A. The Arrhenius curves of three-layer structure-CSEs having LiTFSI:SN=1:8 mol. % and LiTFSI:SN=1:19 mol. % are well consistent with the ion conduction control of the plastic crystal electrolyte, and this indicates that the plastic crystal electrolyte contributes more to Li-ion conduction in the three-layer structure-CSEs. The samples having two different concentrations have similar ionic conductivities of about 1.0 mS/cm at 25° C. The three-layer structure-CSE having LiTFSI:SN=1:8 mol. % has a higher Li-ion concentration and mobility (liquid phase) than the three-layer structure-CSE having LiTFSI:SN=1:19 mol. %, and thus has a higher ionic conductivity in all temperature ranges. (FIG. 6) The ionic conductivity of the LGLZO pellet at 25° C. is 1.0 mS/cm and the activation energy is 0.30 eV. (FIG. 8A) The IPI layer having LiTFSI:SN=1:19 mol. % also has a high ionic conductivity of 1.0 mS/cm at 25° C., but has a much lower activation energy of 0.14 eV (FIG. 8B). In FIG. 2A, two different three-layer structure-CSEs have a high activation energy of 0.235 and 0.240 eV, respectively, and these are rather similar to that of the LGLZO pellet. This means that the IPI layer is not the main ion conduction path, but LGLZO is the dominant path for Li-ion conduction in the three-layer structure-CSE.

A second aspect of the present disclosure provides an all-solid-state battery manufactured using the three-layer structure composite electrolyte according to item 1.

Detailed description of parts overlapping with the first aspect of the present invention has been omitted, but the description of the first aspect of the present invention can be applied equally even if the description is omitted in the second aspect.

Hereinafter, the all-solid-state battery manufactured using the three-layer structure composite electrolyte of item 1 according to the second aspect of the present disclosure will be described in detail.

In an exemplary embodiment of the present disclosure, the electrochemical potential window of the three-layer structure-CSE is investigated at a scan rate of 1 mV s⁻¹ and from 3.0 to 5.5 V in an SS|three-layer structure-CSE|Li-metal cell by a linear sweep voltammetry (LSV). (See FIG. 2B) An increase in current is observed at 5.0 V for the three-layer structure-CSE having LiTFSI:SN=1:8 mol. %, and an increase in current is observed at 5.3 V for the three-layer structure-CSE having LiTFSI:SN=1:19 mol. %. Because of the solid phase of the three-layer structure-CSE having LiTFSI:SN=1:19 mol. %, this CSE has a wider electrochemical window than the three-layer structure-CSE having LiTFSI:SN=1:8 mol. %. A three-layer structure-CSE exhibiting high electrochemical stability can be well matched with a high voltage-cathode for high energy density batteries.

In an exemplary embodiment of the present disclosure, the Li-ion transfer number, trit, in a solid electrolyte is another important factor for evaluating the mobility of Li ions. Solid electrolytes such as an oxide type and a sulfide type having a high trit can lead to uniform diffusion and deposition of Li ions since immobilized anions avoid the formation of space charge regions on the Li metal anode surface. FIGS. 2C and 2D illustrate the current stability curves of Li|three-layer structure-CSE|Li cells. The initial current (I₀) and the steady-state current (Iₛₛ) for the three-layer structure-CSE having LiTFSI:SN=1:8 mol. % are 0.118 μA and 0.109 μA, respectively, as illustrated in FIG. 2C. The current stability curve in FIG. 2D shows an initial current (I₀) of 0.358 μA and a steady-state current (Iₛₛ) of 0.313 μA for the three-layer structure-CSE having LiTFSI:SN=1:19 mol. %. The initial and steady-state impedance diagrams are illustrated in the insets of FIGS. 2C and 2D. Here, R_{b} and Rᵢ are the bulk resistance and the interfacial resistance, respectively. The charge-transfer resistance is expressed as R_{b}+Rᵢ. Specifically, t_{Li+} for the three-layer structure-CSEs reaches 0.89 and 0.83 in the case of LiTFSI:SN=1:8 mol. % and the case of LiTFSI:SN=1:19 mol. %, respectively. These values are much higher than those for conventional polymer electrolytes (typically 0.2 to 0.5) at 25° C. It can be seen that the high value of trit is due to the fact that single ionic-conductive ceramics dominate Li-ion conduction in the three-layer structure-CSEs.

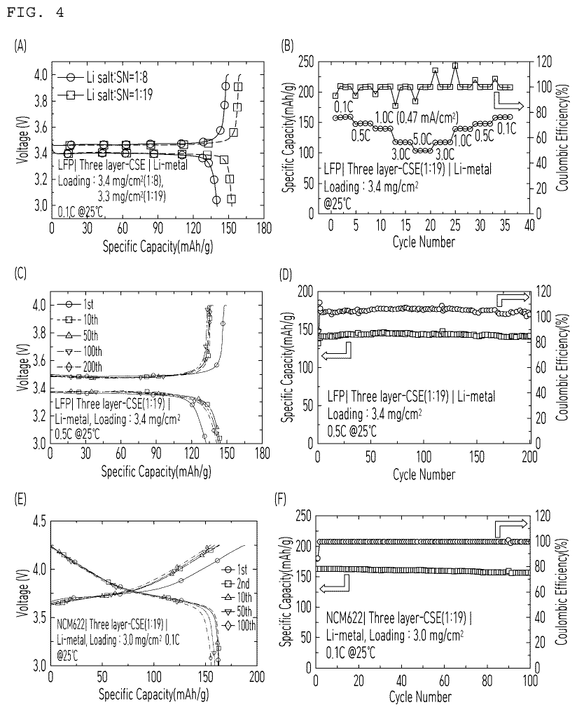

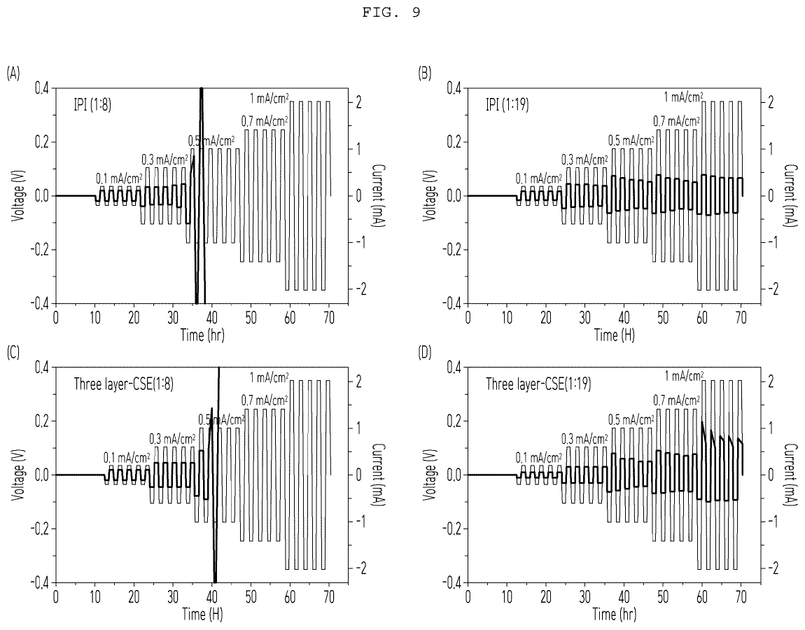

In an exemplary embodiment of the present disclosure, comparative polarization tests of symmetric Li cells including two different three-layer structure-CSEs are illustrated in FIG. 2. The cells including two different three-layer structure-CSEs were stabilized at about 25 mV, and operated for 800 hours or more at a current density of 0.1 mA cm⁻¹ and an area capacity of 0.1 mAh cm⁻². The stability between the initial and final periods of these cycles is consistent with the results of LSV and interfacial impedance tests. Furthermore, the improved interfacial properties of the three-layer structure-CSE can also lead to excellent cycling stability of the cell. The polarization behavior of IPI and three-layer structure-CSE having two different PCE concentrations is also evaluated at various current densities from 0.1 mA/cm-to 1.0 mA/cm². (FIG. 9) The solid electrolyte containing PCE at 1:8 mol. % exhibits short-circuit characteristics at a current density of 0.5 mA/cm² as illustrated in FIGS. 4A and 4C. However, the solid electrolyte containing PCE at 1:19 mol. % exhibits stable cycling performance up to a high current density of 1.0 mA/cm² in FIGS. 4B and 4D. Because of the solid state of PCE having a concentration of 1:19 mol. %, the solid electrolyte containing PCE at 1:19 mol. % is more stable at a high current density. Therefore, it can be said that an all-solid-state battery containing PCE at 1:19 mol. % has the potentiality for much higher performance, particularly under high output conditions.

Hereinafter, Examples of the present invention will be described in detail so that those skilled in the art to which the present invention pertains can easily implement the present invention. However, the present invention can be implemented in various different forms and is not limited to Examples described herein.

### Example 1: Preparation of Oxide-Based Three-Layer

### Composite Electrolyte 1. Synthesis of Ga-Doped LLZO (LGLZO) Powder

Ga-doped LLZO powder for solid electrolytes is synthesized by a conventional solid phase reaction. According to the target stoichiometry of LGLZO, Li₂CO₃ (99.9%, Aldrich), Ga₂O₃ (99.99%, Aldrich), La₂O₃ (99.99%, Aldrich) and ZrO₂ (99.9%, Terio) were mixed in ethanol for 24 hours by a ball mill process and dried in a vacuum at 70° C. for 3 hours. Before mixing, the La₂O₃ powder is preheated at 900° C. for 12 hours to remove surface hydroxides. In order to compensate for the Li-loss that occurs during two times of calcination processes, LiCO₃ is additionally supplied by 10 mol %. The mixed powder is calcined in an alumina crucible in air at 900° C. for 6 hours and then ball milled again in a zirconia crucible for 12 hours. The milled powder is calcined for a second time in an alumina crucible at 1100° C. for 6 hours. Finally, the powder is pulverized and classified using a 325 mesh (44 μm) to obtain proper particles of 1 to 10 μm.

### 2. Ionic-Conductive Polymer Interface (IPI)

Lithium bis(trifluoromethanesulfone)imide (LiTFSI, 99%, Sigma-Aldrich) and succinonitrile (SN, 99.9%, Sigma-Aldrich) are mixed at a ratio of 1:19 mol. % by performing stirring at 50° C. and 300 rpm for 12 hours. Then, 2.5 g of PCE, 1.5 g of poly (vinylidene fluoride-co-hexafluoropropylene) (PVDF-HFP, Mw=400, 000, Sigma-Aldrich) and 6 g of acetone (99.5%, Daejung) were mixed by performing stirring at 80° C. and 300 rpm for 12 hours. In order to fabricate IPI, the mixed solution was cast on a glass plate equipped with a doctor blade at a moving speed of 10 mm/s. Acetone is evaporated by drying the glass plate on a hot plate at 50° C. for 1 hour. The thickness of the IPI layer is about 10 μm. Finally, the IPI layer is punched into coins with a diameter of 18 pie for electrochemical measurement.

### 3. Preparation of Three-Layer Structure—CSE

First, 0.5 g of LiTFSI/SN (1:19 mol. %) is added to a mixed solution of 0.2 g of PVDF-HFP and 2.0 g of acetone and stirring is performed at 80° C. and 300 rpm for 12 hours. Then, 2.8 g of LGLZO powder is added to 2.7 g of IPI solution and stirring is performed at 25° C. and 1000 rpm for 30 seconds. In order to fabricate a three-layer structure-CSE, first an IPI film with a thickness of 10 μm is prepared. Doctor blade casting of CSE is performed on the prepared IPI layer. Another IPI layer is fabricated on the CSE layer using a doctor blade, and then drying is performed at 50° C. for 1 hour. The total thickness of the three-layer structure-CSE is about 50 μm. Finally, the three-layer structure-CSE is punched into coins with 18 pie for electrochemical measurement. The whole fabrication is performed in a glove box filled with argon (H₂O, O₂<0.1 ppm).

### Example 2: Preparation of all-Solid-State Battery

First, the electrochemical performance of a solid-state battery is evaluated through the fabrication of a coin cell (CR2032). For the solid-state battery, LFP or NCM622, Li-metal, and the three-layer structure-CSE are used. The cathode is composed of LFP/Carbon black/PVDF (80:10 wt. %), and the mass loading is 3.4 mg/cm². The measurement condition is C-rate 0.5 C, the voltage range is 3 to 4 V at 25° C., and C-rate performance is evaluated within 0.1 to 5 C. NCM622, Li-metal and the three-layer structure-CSE are also used. The cathode is composed of NCM622/Carbon black/PVDF (80:10 wt. %), and the loading is 3.0 mg/cm². The measurement condition is 0.1 C at 25° C., and the voltage range is 3 to 4.25 V.

Second, the electrochemical performance of an all-solid-state battery is evaluated through fabricating a 3450-sized pouch cell. LFP or NCM622, Li-metal and the three-layer structure-CSE are also used in the same configuration. The cathode is composed of LFP/Carbon black/PVDF (80:10:10 wt. %). The measurement conditions are C-rate of 0.1 C at 25° C. and a voltage range of 3 to 4 V. In order to reduce the interfacial resistance between the active material and the electrolyte at the cathode, the surface of the cathode was impregnated with 10 μl of the so-called cathode electrolyte of EC/DEC/PVA-CN (3 wt. %).

### Comparative Example 1: Ionic-Conductive Polymer Interface (IPI) Single Film Electrolyte and Battery Manufactured Using the Same

Lithium bis(trifluoromethanesulfone) imide (LiTFSI, 99%, Sigma-Aldrich) and succinonitrile (SN, 99.9%, Sigma-Aldrich) are mixed at a ratio of 1:19 mol. % by performing stirring at 50° C. and 300 rpm for 12 hours. Then, 2.5 g of PCE, 1.5 g of poly (vinylidene fluoride-co-hexafluoropropylene) (PVDF-HFP, Mw=400, 000, Sigma-Aldrich) and 6 g of acetone (99.5%, Daejung) were mixed by performing stirring at 80° C. and 300 rpm for 12 hours. In order to fabricate IPI, the mixed solution was cast on a glass plate equipped with a doctor blade at a moving speed of 10 mm/s. Acetone is evaporated by drying the glass plate on a hot plate at 50° C. for 1 hour. The thickness of the IPI layer is about 10 μm. Finally, the IPI layer is punched into coins with a diameter of 18 pie for electrochemical measurement.

### Comparative Example 2: Preparation of all-Solid-State Battery

An all-solid-state battery was fabricated in the same manner as in Example 2 using the IPI single film prepared through Comparative Example 1.

Experimental Example 1: Material Characterization The microstructures of LGLZO powder and CSE are analyzed using a field emission scanning electron microscope (FE-SEM, Hitachi S-4800). The distribution of elements on the CSE surface is observed using energy dispersive X-rays (EDX, Hitachi S-4800). The crystal structures of LGLZO powder and composite solid electrolyte are analyzed by X-ray diffraction (XRD, Rigaku Smart Lab) between 10° and 50°. In order to analyze the chemical bonds of pristine LGLZO, IPI and CSEA, a Fourier transform infrared spectroscope (FT-IR, Nicolet 6700) is used in a wavenumber region (800 to 2300 cm⁻¹). Raman spectroscopic (XPE-35 VPHG, Nanobase) measurement is performed using a DPSS laser Raman module with a wavelength of 532 nm. Thermal stability of IPI and CSE is measured by thermogravimetric analysis (TGA, TG209) under Ne at a ramping rate of 25° C. to 800° C.

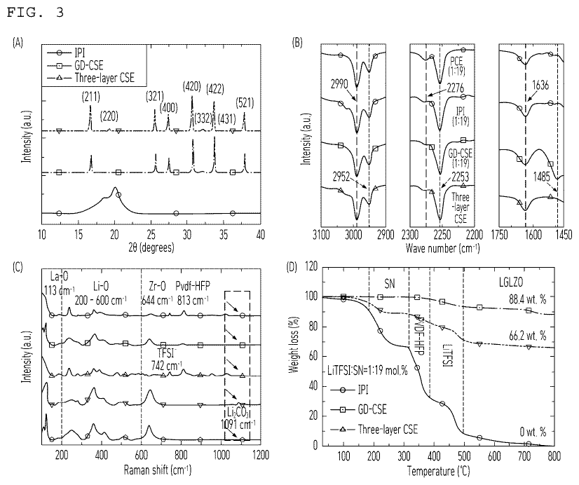

The XRD patterns of the three-layer structure-CSE, GD-CSE and IPI can be compared as illustrated in FIG. 3A. Initially, IPI only shows broadband peaks at 18° and 20°, mainly attributed to PCE as a Li-ion conductor, which can reduce the crystallinity of the polymer, that is, PVDF-HFP. Therefore, PCE enhances the movement of chain segments of the polymer, thereby facilitating the migration of Li ions. More specifically, SN is chosen as a plasticizer because of its ability to weaken van der Waals force of the PVDF-HFP macromolecule and hydrogen bonds between chain segments. SN also has a strong polar —C≡N group, and this can promote the dissolution and dissociation of Li-salt through intermolecular interaction. As a result, the XRD pattern of IPI has broadband diffraction peaks at 18° and 20° as mentioned above.

The cubic phase crystallinity of LGLZO remains during the solution process during which the polymer (PVDF-HFP) and PCE are added (see top and middle of FIG. 1A). These results indicate that there is no side reaction between LGLZO ceramic, PVDF-HFP, LiTFSI, and SN in any preparation process of the composite electrolyte. The XRD pattern of GD-CSE did not reflect any pattern of IPI because of the significantly low IPI content (less than 10 wt. %) and amorphous characteristic. It can be seen that the XRD intensity of IPI in the three-layer structure-CSE at 20° is still low, and this is also due to the low content of IPI (25 to 30 wt. %) and the amorphous phase of IPI.

It is known that SN can be easily polymerized when in contact with La ions on the surface of LGLZO due to the catalytic behavior of La, although there is no noticeable reaction in the XRD pattern analysis. Hence, FT-IR spectra of pure PCE (1:19), IPI (1:19), GD-CSE (1:19), and three-layer structure-CSE (1:19) are obtained as illustrated in FIG. 3B. First, the trans-gauche stretching mode of the C—H vibrational region in SN is required to be checked to impart Li-ion conduction in CSE. The peaks at 2,990 and 2,952 cm⁻¹ are due to the presence of isomeric forms, which are observed in all samples. Second, the coordination of Li ions by C═N in SN indicates the amount of dissolved Li ions that can participate in Li-ion conduction, aka, solvated SN. The peaks at 2,253 and 2,276 cm⁻¹ are the stretching modes of C═N in free and solvated SN, respectively. There is no noticeable peak shift in all samples, and this indicates that equal dissolution occurs in this composite electrolyte. Finally, polymerization of nitrile groups in SN due to strong coordination interaction with La ions is known to reduce the ionic conductivity of LiTFSI dissolved SN electrolyte. Specifically, when polymerization occurs, new peaks at 1,550 cm⁻¹ for C═C and 1625 cm⁻¹ for C═N should appear simultaneously. In all samples, only one peak is observed at 1, 636 cm⁻¹, and this is observed in stretching mode due to partial aggregation of LITFSI but not in polymerization. When the FTIR powder spectrum of LGLZO is checked, it should be mentioned that the additional peak at 1,485 cm⁻¹ in GD-CSE (1:19) is attributed to LLZO. This Li₂CO₃ layer on the garnet electrolyte may lead to deterioration of the interfacial properties of the garnet ceramic electrolyte with electrodes and low ionic conductivity of the composite solid electrolyte. According to prior arts, the intensity of the carbonate peak at 1100 cm⁻¹ increased with exposure time, and this indicates the growth of carbonate layer on the LLZO surface. In the case of LLZO exposed to dry air for the same exposure time, the low intensity Li₂CO₃ peak at 1100 cm⁻¹ (RH approx. 0.5%) suggests that the moisture content at the time of exposure plays an important role in the formation rate of LiCO₃ on the LLZO surface compared to ambient air (RH approx. 50%).

In order to investigate the formation of Li₂CO₃, the Raman spectra of five different samples of three-layer structure-CSE (1:19), GD-CSE (1:19), IPI (1:19), and LGLZO after exposure to humid air and argon (in a glove box) were measured as illustrated in FIG. 3C. As shown in the second spectrum at the bottom, a carbonate peak at 1100 cm⁻¹ appears after exposure to humid air, indicating the formation of a carbonate layer on the LLZO surface. On the other hand, as shown in the bottom spectrum, a peak attributed to Li₂CO₃ is not observed at 1100 cm⁻¹ for LLZO exposed to dry air (RH approx. 0.5%). As a prominent peak attributed to Li₂CO₃ is not observed in the three-layer structure-CSE and GD-CSE, it can be explained that the three-layer structure composite electrolyte of the present invention has a high Li-ion conductivity without any interface problem due to the formation of Li: CO₃.

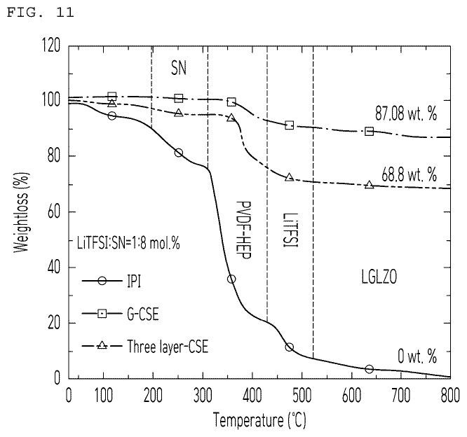

In order to define the final electrolyte composition, TGA was performed. Initially, the weight loss curve of IPI (FIG. 3D) indicates that the PVDF-HFP/LiTFSI/SN composition starts to lose weight at about 150° C., and this corresponds to the pyrolysis temperature of SN. PVDF-HFP thermally decomposes in the temperature range of 320° C. to 400° C. The remaining LiTFSI decomposes at temperatures of 400° C. or more. GD-CSE (FIG. 3D) shows the first noticeable weight loss at about 400° C., and this is due to the small amounts of SN and PVDF-HFP in GD-CSE. At 800° C., 88.4 wt. % of LGLZO remains, and this indicates the dominant content of LGLZO in GD-CSE. In addition, IPI, GD-CSE and the three-layer structure-CSE with another molar ratio (1:8) of LiTFSI/SN show TGA results similar to those for the previously described samples (see FIG. 11).

### Experimental Example 2: Electrochemical Measurement

Electrochemical Impedance Spectroscopic (EIS) measurement is performed using a stainless steel (SS)/GD-CSE/SS cell structure through an electrochemical workstation (WonATech). The measurement conditions are an alternating current amplitude voltage of 10 mV, a frequency of 1 MHz to 100 Hz, and a temperature range of 25° C. to 90° C. Ionic conductivity (o) is calculated using the equation below.

$$σ = \frac{L}{RS} \qquad [ Equation 1 ]$$

where R(ω) denotes the bulk resistance value, and L (cm) and S (cm²) denote the thickness and area of the electrolyte, respectively.

Linear sweep voltammetry (LSV) is performed using a SS/CSE/Li cell structure. The scan rate is 1 mV/s and the voltage range is 3 to 6V at 25° C. The lithium transfer number trit is calculated by applying direct current (DC) polarization with alternating current impedance in a symmetrical lithium cell, and this can be estimated using Equation 2 below.

$${t}_{{Li}^{+}} = \frac{{I}_{ss} ( Δ V - {I}_{0} {R}_{0} )}{{I}_{0} ( ΔV - {I}_{ss} {R}_{ss} )} \qquad [ Equation 2 ]$$

Here, ΔV is the applied voltage (10 mV), I₀ and Iₛₛ are the initial and steady-state currents, respectively. R₀ and Rₛₛ denote the initial charge-transfer resistance and steady-state charge-transfer resistance during the direct current (DC) polarization process, respectively. The Li/Li symmetric cell measurement is performed using a Li/CSE/Li cell structure. Interfacial compatibility between the electrolyte and the lithium metal is measured by recording galvanostatic cycling of a symmetric Li battery by charge and discharge at 25° C. for 1 hour at a current density of 0.1 mA/cm².

In order to demonstrate the functionality of the oxide-based three-layer structure composite electrolyte (three-layer structure-CSE) of the present invention in actual battery applications, solid-state batteries are assembled and various electrochemical performances thereof are tested. The voltage profile of the LFP|three-layer-CSE having two different PCE concentrations is illustrated in FIG. 4A. At 0.1 C and 25° C., the batteries have discharge capacities of 152 and 140 mAh/g when having different PCE concentrations of 1:19 mol. % and 1:8 mol. %. FIG. 3B illustrates the galvanostatic cycling performance of an LFP|three-layer structure-CSE (1:19)|Li-metal battery at various current densities and 25° C. Discharge capacities of about 158, 147, 139, 116, and 102 mAh/g were obtained at different rates of 0.1, 0.5, 1.0, 3.0, and 5.0 C, respectively. Furthermore, the reversible discharge capacity is well recovered and remains stable when the current density returns to 0.1 C, indicating that the electrolyte/electrode interface exhibits favorable electrochemical stability during the rapid charge and discharge process. FIGS. 4C and 4D illustrate the voltage profile and galvanostatic cycling performance of an LFP|three-layer structure-CSE (1:19)|Li-metal battery at 0.5 C and 25° C. The battery including a three-layer structure-CSE after 200 cycles or more has only a weak polarization effect. An initial specific capacity of 141.5 mAh/g was achieved with a high capacity retention rate of almost 100% after 200 cycles. The excellent cycling stability of the cell is mainly due to the high Li-ion conductivity, high trit and desirable electrolyte/electrode interface compatibility. Moreover, FIGS. 4E and 4F illustrate the voltage profile and galvanostatic cycling performance of an NCM622|three-layer structure-CSE (1:19)|Li-metal battery at 0.1 C, respectively. The initial specific capacity with a high capacity retention rate of 100% is 162 mAh/g with a high capacity retention rate of 95.8%.

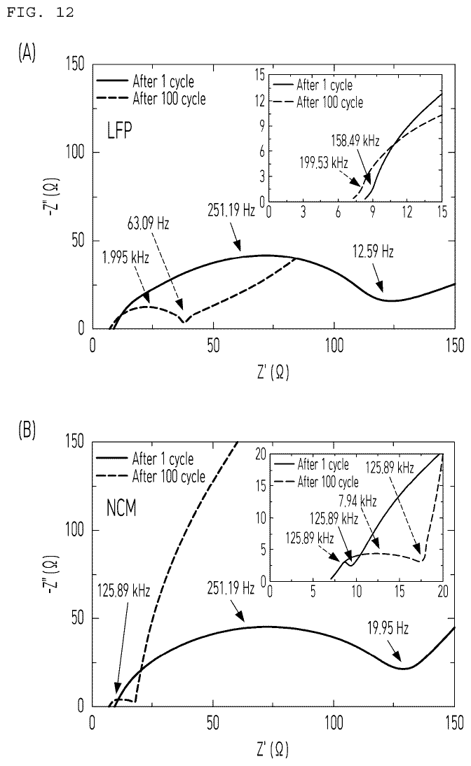

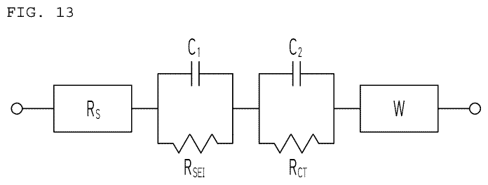

In order to investigate the interfacial resistance of the cell, the EIS spectra of the LFP|three-layer structure-CSE (1:19)|Li-metal battery and NCM622|three-layer structure-CSE (1:19)|Li-metal battery are measured as illustrated in FIG. 12, respectively. The Nyquist plot was fitted with the equivalent circuit reported in FIG. 13 and the calculated resistances were listed as presented in Table 2. Immediately after the formation cycling (1st cycle), the series resistance (R1) is about 9 Ohm for both of the two cells, and this is similar to the series resistance of the three-layer structure-CSE itself. The interfacial resistance (R2) from the solid electrolyte interface (SEI) and cathode electrolyte interface (CEI) formation is 27 and 42 Ohm in the LFP and NCM cells, respectively. Bulk resistance (R3) is 73 and 52 Ohm in the LFP and NCM cells, respectively. The bulk as well as the interfacial resistance of the two samples decrease dramatically after 100 cycles. Repeated experiments had the same results, and additional analyses were performed by different measurement to investigate this dramatic decrease in resistance. So far, additional stabilization of the resistance during the charge and discharge process or during the growth of micro Li-dendrites may have influenced such results. Nonetheless, such results indicate high electrochemical performance of this composite electrolyte when this composite electrolyte is used in all solid-state lithium-metal batteries.

Moreover, recent results of similar studies on LLZO contained in a large amount in CSE are presented in Table 1. When the ionic conductivity at room temperature and the cycle maintenance after 100 cycles are compared, the oxide-based three-layer structure composite electrolyte (three-layer structure-CSE) of the present invention shows noticeable results.

TABLE 1

| | | Ionic | [symbol] | | | | | Specific | Cycle | |
|---|---|---|---|---|---|---|---|---|---|---|
| | Solid | [symbol] | [symbol] | [symbol] | | | Voltage | Capacity | Performance | |
| No. | Electrolyte | (S/ [symbol] ) | [symbol] | Number | Cathode | Anode | window | [symbol] | (%) | Reference |
| 1 | [symbol] | [symbol] | [symbol] | [symbol] | LFP | [symbol] | [symbol] | [symbol] | [symbol] | [25] |
| | [symbol] | | | | | | | [symbol] | [symbol] | |
| | [symbol] | | | | [symbol] | [symbol] | [symbol] | [symbol] | [symbol] | |
| | | | | | | | | [symbol] | [symbol] | |
| 2 | [symbol] | [symbol] | [symbol] | — | [symbol] | Li | [symbol] | [symbol] | [symbol] | [ [symbol] ] |
| | [symbol] | [symbol] | | | | | | [symbol] | [symbol] | |
| | [symbol] | | | | | | | | | |
| 3 | [symbol] | [symbol] | [symbol] | [symbol] | [symbol] | Li | [symbol] | [symbol] | [symbol] | [ [symbol] ] |
| | [symbol] | | | | | | | [symbol] | [symbol] | |
| 4 | [symbol] | [symbol] | [symbol] | — | [symbol] | Li | [symbol] | [symbol] | [symbol] | [ [symbol] ] |
| | [symbol] | [symbol] | | | | | | [symbol] | [symbol] | |
| 5 | [symbol] | [symbol] | [symbol] | [symbol] | [symbol] | Li | [symbol] | [symbol] | [symbol] | [ [symbol] ] |
| | [symbol] | [symbol] | | | | | | [symbol] | [symbol] | |
| 6 | [symbol] | [symbol] | — | — | — | — | — | — | — | [ [symbol] ] |
| | [symbol] | [symbol] | | | | | | | | |
| 7 | [symbol] | [symbol] | [symbol] | [symbol] | [symbol] | Li | [symbol] | [symbol] | [symbol] | This work |
| | [symbol] | [symbol] | | | | | | [symbol] | [symbol] | |
| | [symbol] | | | | [symbol] | Li | [symbol] | [symbol] | [symbol] | |
| | | | | | | | | [symbol] | [symbol] | |

[symbol]

indicates data missing or illegible when filed

TABLE 2

| Cell | | R_{S} (Ω) | R_{SEI} (Ω) | R_{CT} (Ω) |
|---|---|---|---|---|
| LFP | After 1 cycle | 9.11 | 27.06 | 72.94 |
| | After 100 cycle | 8.19 | 13.19 | 15.41 |
| NCM | After 1 cycle | 9.71 | 42.25 | 52.49 |
| | After 100 cycle | 8.03 | 1.21 | 8.15 |

### Experimental Example 3: Large-Area Pouch-Type all-Solid-State Battery

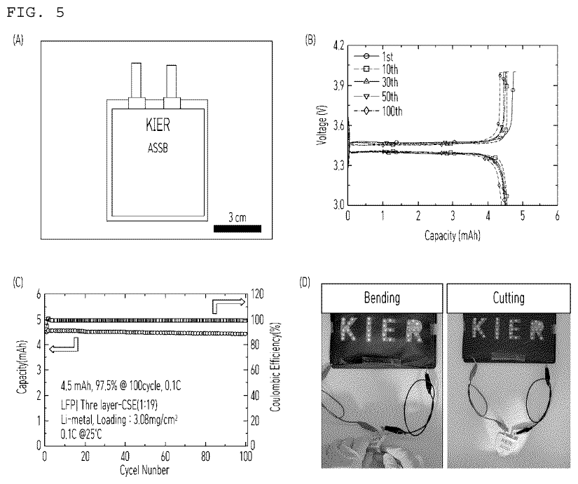

The usability of the three-layer structure-CSE in large-area pouch-type cells was evaluated. Li-metal pouch-type cells including LFP|three-layer structure-CSE were assembled, and the electrochemical and deformable properties thereof are illustrated in FIG. 5. FIG. 5A illustrates an image of a 3450-sized pouch cell. FIGS. 5B and 5C illustrate the voltage profile and galvanostatic cycling performance of the LFP|Li-metal cell at 0.1 C rate, 25° C., and from 3.0 to 4.1 V, respectively. The LFP|Li-metal-cell has an initial discharge capacity of 4.5 mAh with a high capacity retention rate of 97.5% after 100 cycles, and this indicates the high ionic conductivity of CSE during cycling and the excellent interfacial stability between CSE and LFP, the anode and CSE and Li-metal anode. The composite electrolyte allows for batteries exhibiting high safety and durability in practical applications, and the pouch-type cell can light a diode array even under bent and cut situations in FIG. 5D.

The present results suggest that the combination of SN and LITFSI electrolytes with garnet-based frameworks to form high-performance-composite-solid electrolytes is particularly well suited for practical realization of high-safety, high-energy-density, and durable solid-state Li-metal batteries. Moreover, the unique three-layer structure may also be applicable to other ceramic electrolyte systems and may show great feasibility for applications to high-performance solid-state batteries.

The foregoing description of the present invention is for illustrative purposes only, and those skilled in the art to which the present invention pertains will understand that the present invention can be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

According to an embodiment of the present invention, the oxide-based three-layer structure composite electrolyte of the present invention provides a composite solid electrolyte with a three-layer structure in which GD-CSE (garnet dominant-composite solid electrolyte) is the center layer and IPI (ionic polymer interlayer) is the upper and lower layers.

According to an embodiment of the present invention, the oxide-based three-layer structure composite electrolyte is thin, exhibits favorable flexibility, has a high ionic conductivity at room temperature, exhibits excellent electrochemical stability, is suitable for large-area production, and can be thus put into practical use.

According to an embodiment of the present invention, the oxide-based three-layer structure composite electrolyte can have a high room temperature ionic conductivity (1.0 mS/cm), excellent electrochemical stability (more than 5.0 V versus Li/Li⁺), and a high lithium ion transfer number (˜0.80).

In addition, the three-layer structure-CSE can have safety and applicability through assembled Li|Li symmetric cell, LFP|Li and NCM|Li cells, and can have safety and applicability by assembling an LFP|Li pouch cell and showing the excellent electrochemical, bending, and cutting performance.

The effects of the present invention are not limited to the effects described above, and should be understood to include all effects that can be inferred from the configuration of the invention described in the description or claims of the present invention.

While the present invention has been described with respect to the specific embodiments, it will be apparent to those skilled in the art that various changes and modifications may be made without departing from the spirit and scope of the invention as defined in the following claims.

1. A three-layer structure composite electrolyte comprising: an oxide-based solid electrolyte center layer (CSE, composite solid electrolyte); and
an ionic polymer interlayer (IPI) disposed on both sides of the solid electrolyte center layer.

2. The three-layer structure composite electrolyte according to claim 1, wherein the oxide-based solid electrolyte center layer (composite solid electrolyte) contains:
an oxide-based solid electrolyte at 75 to 90 wt %;
a binder at 5 to 20 wt %; and
an ionic-conductive additive at 5 to 20 wt %.

3. The three-layer structure composite electrolyte according to claim 1,
wherein the oxide-based solid electrolyte is in a powder form and has a garnet structure.

4. The three-layer structure composite electrolyte according to claim 1,
wherein the oxide-based solid electrolyte has an average powder diameter (D50 in volumetric intensity) of 0.5 to 20 μm.

5. The three-layer structure composite electrolyte according to claim 1,
wherein the oxide-based solid electrolyte is a garnet-type oxide-based solid electrolyte represented by the following Chemical Formula 1:
Li₇₋ₓMₓLa₃Zr₂₋ₓO₁₂ [Chem. 1]
in wherein Chemical Formula 1, M is at least one selected from the group consisting of Ga, Ta, Y, Sc, and Nb, and x is less than 0.7.

6. The three-layer structure composite electrolyte according to claim 1,
wherein the binder of the solid electrolyte is one selected from a poly (vinylidene fluoride-co-hexafluoropropylene) (PVDF-HFP) composite porous polymer, PVDF, and a copolymer thereof.

7. The three-layer structure composite electrolyte according to claim 1,
wherein the solid electrolyte contains a plastic crystal electrolyte (PCE) as an ion conductive additive.

8. The three-layer structure composite electrolyte according to claim 7,
wherein the plastic crystal electrolyte (PCE) contains lithium bis(trifluoromethanesulfonyl)imide (LiTFSI) and succinonitrile (SN) or a dinitrile.

9. The three-layer structure composite electrolyte according to claim 7,
wherein the plastic crystal electrolyte (PCE) is prepared by mixing lithium bis(trifluoromethanesulfonyl)imide (LiTFSI) and succinonitrile (SN) or a dinitrile at a ratio of 1 to 8 to 20 mol. %.

10. The three-layer structure composite electrolyte according to claim 1,
wherein the binder of the ionic polymer interlayer is one selected from a poly (vinylidene fluoride-co-hexafluoropropylene) (PVDF-HFP) composite porous polymer, PVDF, or a copolymer thereof.

11. The three-layer structure composite electrolyte according to claim 1,
wherein the ionic polymer interlayer contains a plastic crystal electrolyte (PCE) as an ion conductive additive.

12. The three-layer structure composite electrolyte according to claim 11,
wherein the plastic crystal electrolyte (PCE) contains lithium bis(trifluoromethanesulfonyl)imide (LiTFSI) and succinonitrile (SN) or a dinitrile.

13. The three-layer structure composite electrolyte according to claim 11,
wherein the plastic crystal electrolyte (PCE) is prepared by mixing lithium bis(trifluoromethanesulfonyl)imide (LiTFSI) and succinonitrile (SN) or a dinitrile at a ratio of 1:8 to 20 mol. %.

14. The three-layer structure composite electrolyte according to claim 1,
wherein a thickness of the three-layer structure composite electrolyte is 30 to 200 μm, and
an ionic conductivity of the three-layer structure composite electrolyte is 0.5 to 1.2 mS/cm.

15. An all-solid-state battery manufactured using the three-layer structure composite electrolyte according to claim 1.

16. The three-layer structure composite electrolyte according to claim 2,
wherein the oxide-based solid electrolyte is in a powder form and has a garnet structure.

17. The three-layer structure composite electrolyte according to claim 2,
wherein the oxide-based solid electrolyte has an average powder diameter (D50 in volumetric intensity) of 0.5 to 20 μm.

18. The three-layer structure composite electrolyte according to claim 2,
wherein the oxide-based solid electrolyte is a garnet-type oxide-based solid electrolyte represented by the following Chemical Formula 1:
Li₇₋ₓMₓLa₃Zr₂₋ₓO₁₂ [Chem. 1]
wherein Chemical Formula 1, M is at least one selected from the group consisting of Ga, Ta, Y, Sc, and Nb, and x is less than 0.7.

19. The three-layer structure composite electrolyte according to claim 2,
wherein the binder of the solid electrolyte is one selected from a poly (vinylidene fluoride-co-hexafluoropropylene) (PVDF-HFP) composite porous polymer, PVDF, and a copolymer thereof.

20. The three-layer structure composite electrolyte according to claim 2,
wherein the solid electrolyte contains a plastic crystal electrolyte (PCE) as an ion conductive additive.
